(19) United States
(12) Patent Application Publication
(10) Pub. No.: US 2019/0386754 A1
(43) Pub. Date: Dec. 19, 2019

(54) METHOD FOR TESTING WIRELESS TRANSCEIVER

(71) Applicant: Goldtek Technology Co., Ltd., New Taipei City (TW)

(72) Inventors: YEN-CHING LEE, New Taipei (TW); FU-YUAN TSAI, New Taipei (TW)

(21) Appl. No.: 16/441,221

(22) Filed: Jun. 14, 2019

(30) Foreign Application Priority Data
Jun. 15, 2018 (TW) 107120887

(51) Int. Cl. H04B 17/17; H04B 17/318; H04B 17/29

(52) U.S. Cl. CPC H04B 17/17; H04B 17/29; H04B 17/318

(57) ABSTRACT

A method for testing a wireless transceiver includes the following steps: electrically connecting a golden sample of the wireless transceiver to a first automatic test equipment (ATE); electrically connecting at least one device under test (DUT) of the wireless transceiver to a second ATE; transmitting a first packet to the golden sample; switching the at least one DUT to a receiving mode; determining whether a second packet from the golden sample is received; and determining whether the at least one DUT is normal based on a receiving result of the at least one DUT when the second packet is received.

### FIELD

The subject matter herein generally relates to testing for electronic devices, and particularly relates to a method for testing a wireless transceiver.

### BACKGROUND

Wireless transceivers are widely used in wireless communication technologies. For example, mobile phones, tablets, Bluetooth headsets, and some watches have wireless transceivers.

The wireless transceivers need to undergo a standardized test process to ensure that the quality meets standards. There are two test processes for the wireless transceivers. The first test is to independently test an antenna and a fundamental frequency circuit of the wireless transceiver. The second test is to analyze a field pattern and spectrum of a signal transmitted and received by the wireless transceiver. Usually, the field pattern and the spectrum both need to be tested. However, when the second method is required, spectrum analysis instruments are required and the operation of the analysis of the spectrum may be cumbersome, which, in turn, may greatly increase the production cost of the wireless transceiver.

Therefore, there is room for improvement within the art.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout several views.

FIG. 1 is a schematic diagram of an operating environment of a method for testing a wireless transceiver according to an embodiment of the present disclosure.

FIG. 2 is a schematic diagram of an operating environment for testing with a golden sample according to an embodiment of the present disclosure.

FIG. 3 is a flowchart of a control method of the golden sample in a testing process.

FIG. 4 is a flowchart of a control method of a device under test (DUT) in the testing process.

FIG. 5 is a flowchart showing how to determine whether the DUT is normal in block 407.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

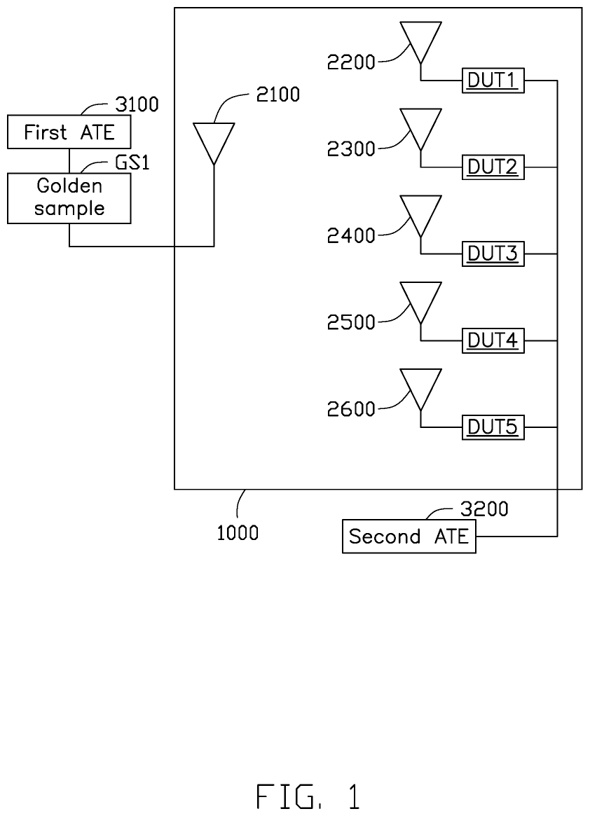

FIG. 1 illustrates a schematic diagram of an operating environment of a method for testing a wireless transceiver. As illustrated in FIG. 1, there are a plurality of antennas, for example, antennas 2100-2600, in a shielding room 1000. The antenna 2100 is configured for being electrically connected to a golden sample GS1. The antennas 2200-2600 are configured for being electrically connected to devices under test (DUTs). There are also a first automatic test equipment (ATE) 3100 and a second ATE 3200 in the test environment.

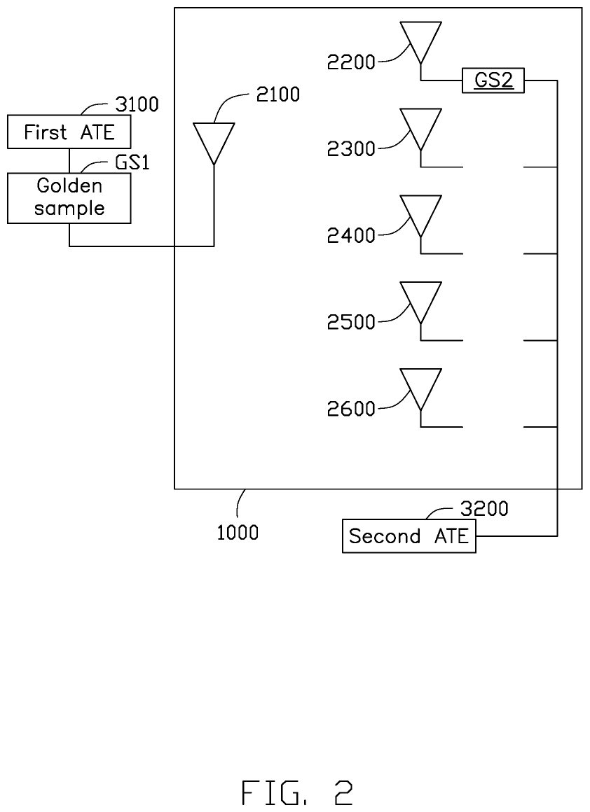

In this embodiment, the manufacturer of the wireless transceivers initially obtains the golden sample GS1 and a golden sample GS2. As shown in FIG. 2, the golden sample GS1 is first electrically connected to the antenna 2100 and the first ATE 3100. The golden sample GS2 is electrically connected to the antenna 2200 and the second ATE 3200. Then the golden sample GS1 and the golden GS2 can be confirmed to be operated normally, and standard parameters for the golden samples GS1, GS2 to be tested in the shielding room 1000 can be obtained.

In one embodiment, the first ATE 3100 and the second ATE 3200 are, for example, general personal computers, but may be industrial computers or other computer devices with computing, data processing, and control capabilities. The wireless transceiver mentioned in the present disclosure is, for example, a long range wide area network (LoRaWAN) wireless transceiver, a Bluetooth wireless transceiver, or a Bluetooth Low Energy (BLE) wireless transceiver.

In the embodiment of FIG. 2, two golden samples GS1, GS2 are used to confirm that the automatic test equipment and the antennas are set correctly. Once one of the golden sample GS1 and the golden sample GS2 cannot correctly send and receive wireless signals, it means that there is a certain link setting error in the entire test environment. Golden samples usually refer to wireless transceivers that the manufacturer has previously verified that the parameters are compliant and functioning properly.

When a production of the wireless transceivers is completed and the devices under test DUT1-DUT5 are obtained. The devices under test DUT1˜DUT5 are placed in the shielding room 1000. Each device under test is electrically connected to a corresponding antenna and is electrically connected to the second ATE 3200. Specifically, the device under test DUT1 is electrically connected to the antenna 2200. The device under test DUT2 is electrically connected to the antenna 2300. The device under test DUT3 is electrically connected to the antenna 2400. The device under test DUT4 is electrically connected to the antenna 2400. The device under test DUT5 is electrically connected to the antenna 2600.

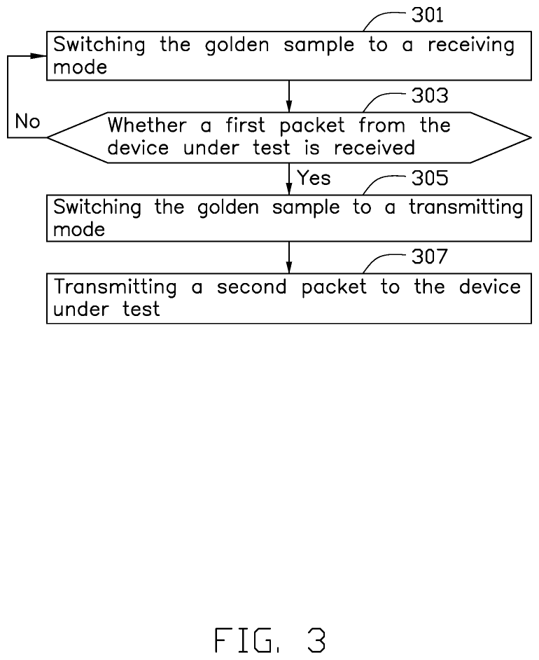

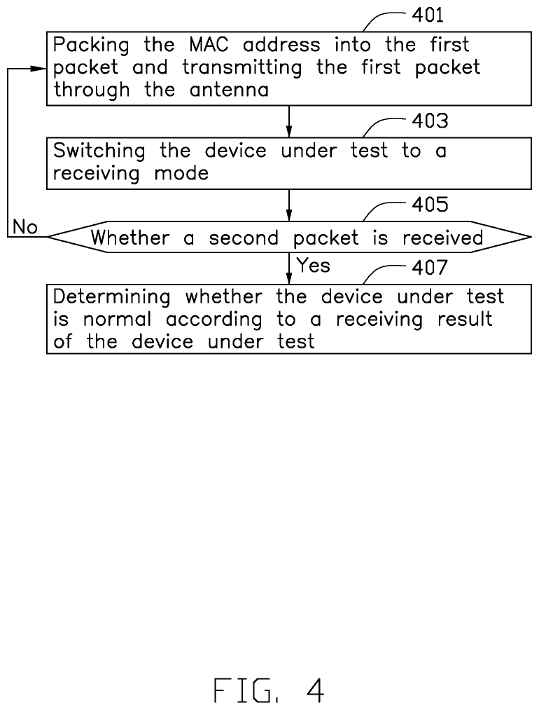

Refer to FIG. 3 and FIG. 4, into the test process, the following is an example of the test for the device under test DUT1, but the person skilled in the art can infer the flow of testing for a plurality of devices under test.

FIG. 3 is a flow chart of a control method of the golden sample GS1 in the testing process. As shown in block 301, the first ATE 3100 controls the golden sample GS1 to switch to a receiving mode.

At block 303, the golden sample GS1 determines whether a first packet from the device under test DUT1 is received. If the golden sample GS1 does not receive the first packet, it returns to block 301. In other words, the golden sample GS1 remains in the receiving mode before the golden sample GS1 receives the first packet.

At block 305, when the golden sample GS1 receives the first packet, the golden sample GS1 is switched to a transmitting mode.

At block 307, the golden sample GS1 transmits a second packet to the device under test DUT1.

FIG. 4 is a flow chart of a control method of the device under test DUT1 in the testing process. As shown in block 401, the device under test DUT1 packs its own Media Access Control address (MAC address) into the first packet and transmits the first packet through the antenna 2200.

At block 403, the device under test DUT1 is switched to a receiving mode.

At block 405, the device under test DUT1 determines whether the second packet from the golden sample GS1 is received.

In one embodiment, when the device under test DUT1 determines the second packet is not received in a time interval, for example, 0.5 seconds, it returns to block 401. In another embodiment, when the device under test DUT1 determines that the second packet is not received, it waits for a period of time, for example, 0.5 seconds, and then returns to block 401. In one embodiment, the time interval is, for example, less than or equal to 2 seconds.

At block 407, when the device under test DUT1 determines that the second packet is received, the second ATE 3200 determines whether the device under test DUT1 is normal according to a receiving result of the device under test DUT1.

In block 405, when the device under test DUT1 repeatedly determines that the second packet is not received, the device under test DUT1 generates an error report. For example, if the device under test DUT1 always cannot receive the second packet, it may be that the first packet cannot be correctly received by the golden sample GS1, or a capability of the device under test DUT1 to receive the signal may be problematic. In this way, when the second ATE 3200 receives the error report from the device under test DUT1, it is determined that the device under test DUT1 is abnormal.

In block 401, the first packet includes information of a transmitting power. In other words, when the golden sample GS1 receives the first packet, the golden sample GS1 calculates a Received Signal Strength Indication (RSSI) according to the transmitting power of the first packet and a received power calculated when the first packet is received. In the field of wireless communications, the RSSI is typically used to reverse a distance between two antennas (that is, two wireless transceivers). However, in this embodiment, the distance between the antenna 2100 and the antenna 2200 is a known fixed value (a preset distance). The preset distance corresponds to a Predetermined Received Signal Strength Indication (PRSSI). For example, the PRSSI may be one of the standard parameters previously obtained when the golden sample GS1 and the golden sample GS2 are transceived through the antenna 2100 and the antenna 2200. The golden sample GS1 embeds the calculated RSSI into the second packet.

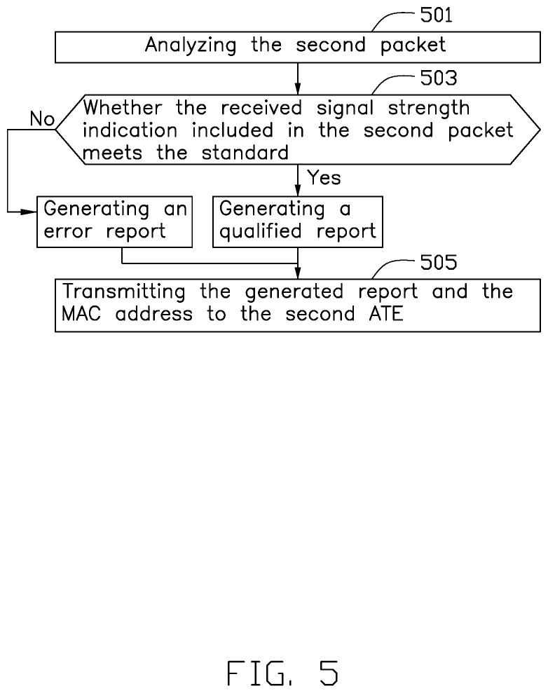

FIG. 5 is a flow chart showing how to determine whether the device under test DUT1 is normal in block 407. As shown in block 501, the device under test DUT1 analyzes the second packet. As mentioned before, the second packet includes the received signal strength indication calculated by the golden sample GS1.

In block 503, the device under test DUT1 determines whether the received signal strength indication included in the second packet meets the standard compared to the predetermined received signal strength indication.

According to an industry standard, when the received signal strength indication included in the second packet is 3 dB smaller than the predetermined received signal strength indication, it is determined that the signal transmission capability of the device under test DUT1 does not meet the standard.

In other embodiments, when the golden sample GS1 transmits the second packet through the antenna 2100, the golden sample GS1 can also embed the information of the transmitting power in the second packet. Then, the device under test DUT1 calculates another Received Signal Strength Indication (RSSI) according to a signal strength when the device under test DUT1 receives the second packet and the transmitting power embedded in the second packet. The received signal strength indication calculated here is a signal receiving capability with respect to the device under test DUT1.

In other embodiments, the device under test DUT1 further determines whether the received packet format is correct. Since the device under test DUT1 is a fundamental frequency circuit of the entire wireless transceiver. If the processed packet format is wrong, it often indicates that the wireless transceiver has flaws in a mixer or a local oscillator (LO) circuit.

In one embodiment, when it is determined that the received signal strength indication does not meet the standard, or the packet format is incorrect, the device under test DUT1 generates an error report, and conversely, the device under test DUT1 generates a qualified report.

As shown in block 505, the device under test DUT1 transmits the generated report (error report or qualified report) and the media access control address (MAC address) to the second ATE 3200. The second ATE 3200 can determine whether the device under test DUT1 is normal or abnormal according to the report transmitted from the device under test DUT1.

When the devices under test DUT1-DUT5 are all tested, the second ATE 3200 will collect a plurality of different reports. Each report corresponds to a media access control address. Therefore, the second ATE 3200 can calculate a yield rate of the devices under test DUT1-DUT5 according to the data.

In summary, the method for testing the wireless transceiver determines whether the devices under test are abnormal through whether the packet is received, whether the packet format is correct, or whether the received signal strength indication meets the standard. Then, the complicated procedure of using the spectrum analyzer and performing field pattern analysis can be avoided, and the probability of occurrence of mistakes caused by human operation can be reduced. At the same time, since the spectrum analyzer is not required, the producer (manufacturer) does not have to purchase a large number of spectrum analyzers, which reduces the production cost.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A method for testing a wireless transceiver, the method comprising:
electrically connecting a golden sample of the wireless transceiver to a first automatic test equipment (ATE);
electrically connecting at least one device under test (DUT) of the wireless transceiver to a second ATE;
switching the golden sample to a receiving mode and determining whether a first packet from the at least one DUT is received by the golden sample;
switching the golden sample to a transmitting mode to send a second packet to the at least one DUT when the first packet is received by the gold sample;
determining whether the second packet is received by the at least one DUT; and
determining whether the at least one DUT is normal based on a receiving result of the at least one DUT when the second packet is received by the at least one DUT.

2. The method of claim 1, further comprising:
determining whether the at least one DUT is normal based on a Received Signal Strength Indication (RSSI) of the receiving result.

3. The method of claim 1, wherein when the first packet is not received, the golden sample remains in the receiving mode.

4. The method of claim 1, wherein before the golden sample is switched to the receiving mode, the method further comprises:
switching the at least one DUT to the transmitting mode to transmit the first packet;
switching the at least one DUT to a receiving mode; and
determining whether the second packet is received by the at least one DUT.

5. The method of claim 4, wherein when the at least one DUT determines the second packet is not received at a time interval, the at least one DUT is switched to the transmitting mode to transmit the first packet.

6. The method of claim 5, wherein the time interval is less than or equal to 2 seconds.

7. The method of claim 1, wherein the first packet comprises a Media Access Control address (MAC address) of the at least one DUT.

8. The method of claim 7, wherein the second ATE calculates a yield rate of the at least one DUT according to the receiving result of each of the DUT.

9. The method of claim 1, wherein when the receiving result indicates a format of the second packet is correct, the at least one DUT is determined to be normal.

10. The method of claim 1, wherein when the receiving result indicates a format of the second packet is wrong, the at least one DUT is determined to be abnormal.

11. A method for testing a wireless transceiver, the method comprising:
electrically connecting a golden sample of the wireless transceiver to a first automatic test equipment (ATE);
electrically connecting at least one device under test (DUT) of the wireless transceiver to a second ATE;
transmitting a first packet to the golden sample;
switching the at least one DUT to a receiving mode;
determining whether a second packet from the golden sample is received by the at least one DUT; and
determining whether the at least one DUT is normal based on a receiving result of the at least one DUT when the second packet is received.

12. The method of claim 11, further comprising:
determining whether the at least one DUT is normal based on a Received Signal Strength Indication (RSSI) of the receiving result.

13. The method of claim 11, wherein when the at least one DUT determines the second packet is not received at a time interval, the at least one DUT is switched to a transmitting mode to transmit the first packet.

14. The method of claim 13, wherein the time interval is less than or equal to 2 seconds.

15. The method of claim 11, wherein the first packet comprises a Media Access Control address (MAC address) of the at least one DUT.

16. The method of claim 15, wherein the second ATE calculates a yield rate of the at least one DUT according to the receiving result of each of the DUT.

17. The method of claim 11, wherein when the receiving result indicates a format of the second packet is correct, the at least one DUT is determined to be normal.

18. The method of claim 11, wherein when the receiving result indicates a format of the second packet is wrong, the at least one DUT is determined to be abnormal.
